(19) United States
(12) Patent Application Publication
(10) Pub. No.: US 2009/0197994 A1
(43) Pub. Date: Aug. 6, 2009

(54) ALGAE FIBER-REINFORCED BICOMPOSITE AND METHOD FOR PREPARING THE SAME

(75) Inventors: Seong-Ok Han, Daejeon (KR); Hong-Soo Kim, Daejeon (KR); Yoon Jong Yoo, Daejeon (KR); Yeong Bum Seo, Daejeon (KR); Min Woo Lee, Daejeon (KR)

Correspondence Address: CANTOR COLBURN, LLP, 20 Church Street, 22nd Floor, Hartford, CT, 06103, US

(73) Assignee: KOREA INSTITUTE OF ENERGY RESEARCH, Daejeon (KR)

(21) Appl. No.: 11/995,512

(22) PCT Filed: Jul. 16, 2007
(86) PCT No.: PCT/KR07/03454

§ 371 Date: Jan. 11, 2008

(30) Foreign Application Priority Data
Oct. 24, 2006 (KR) 10-2006-0103643
May 23, 2007 (KR) 10-2007-0050532

(51) Int. Cl. C08K 11/00; C08J 5/10; C08L 99/00; C08K 7/02

(52) U.S. Cl. 524/9; 264/331.21; 264/331.11

(57) ABSTRACT

Disclosed herein are an environmentally-friendly biocomposite prepared from a mixture, as a reinforcement, of algae fibers extracted from algae and a polymeric reagent by means of high-temperature compression-molding, and a method for preparing the biocomposite.

### BACKGROUND OF THE INVENTION

1. Field of the Invention

The present invention relates to a algae fiber-reinforced biocomposite and a method for preparing a biocomposite. More specifically, the present invention relates to an environmentally-friendly biocomposite prepared by mixing a polymeric reagent powder with an algae fiber reinforcement obtained by solvent extraction and decoloration, filling a mold with the mixture, and pressing the mold at a high temperature. Furthermore, the present invention relates to a method for preparing a biocomposite which comprises the step of grinding/dissociating dried algae fibers with a high-temperature grinder so as to improve dispersability of the algae fiber reinforcement in the biocomposite, and the biocomposite prepared by the method.

2. Description of the Related Art

Polymeric composites generally used in the automobile and building industries mostly use glass fiber as a reinforcement. Glass fiber is harmful to human body and is difficult to recycle, thus causing a number of energy and environmental problems. In order to reduce the use of such glass fiber, biocomposites employing natural fiber reinforcements are being recently used.

Biocomposites employ wood or fiber extracted from non-wood natural fibers as a reinforcement, and have a light weight (i.e. about 30% or more weight-reduction), as compared to glass fiber-reinforced composites, thus being expected to be a new advanced material that has the potential of enhancing fuel-efficiency when being applied to components of automobiles. However, the composition and size of fibers are varied according to factors such as growth regions, growth conditions, growth sites and growth periods of woods or specific non-wood plants. For this reason, biocomposites which employ natural fibers in itself as reinforcements have a problem of having non-uniform properties. Other problems of the biocomposites are damage to forests and reverse-effects associated with cultivation of specific nonwood-based plants (e.g. flax or hemp).

On the other hand, a gel extract obtained from the inside of algae is utilized in food additives, health care products and agar materials. However, until now, there was almost no field utilizing algae fibers. Thus, algae fibers were mostly wasted. Accordingly, when biocomposites reinforced with algae fibers are applied to interior or exterior materials of automobiles and houses, they contribute to environmental protection due to a reduction in wastes, have lightweight and superior structural properties, as compared to glass fiber-reinforced biocomposites, thus being promising as next-generation environmentally-friendly biocomposites.

In addition, algae are grown for a short time and are controllable to have a desired composition and a uniform size according to culturing methods. Based on these properties, algae fiber-reinforced biocomposites can have uniform mechanical properties, as compared to cellulose-reinforced biocomposites. Besides, when cultured for mass-production, algae are obtained with high quality in spite of a short culturing period of time. Furthermore, the culturing of algae results in an additional effect of a reduction in carbon dioxide through photosynthesis of algae.

Algae fiber-reinforced biocomposites exhibit superior dynamic properties, as compared to conventional natural fiber-reinforced biocomposites. In particular, algae fibers show superior thermal stability, as compared to cellulose fibers. Accordingly, the danger that the thermal stability of reinforcements is deteriorated during preparation of biocomposites is relatively low. Besides, biocomposites comprising reinforcements with superior dispersability can be prepared with a preparation process which introduces a high-temperature grinding technique capable of simultaneously performing drying, grinding and dissociating of algae fibers.

There are a variety of prior arts of the present invention associated with the use of algae fibers. As domestic patents, Korean Patent Publication No. 2006-0002675 (Yoo Kook-hyeon) discloses decoloration and purification of algae fibers in which polysaccharide is removed from algae by hydrolysis and the algae fibers are bleached with oxidizing and reducing agents. In addition, Korean Patent Publication No. 2006-0000695 (the same applicant as above) discloses a method for extraction-separating algae fibers from processed algae and by-products and a method for preparing a functional novel-advanced material film by extruding a composition comprising the separated dried algae fibers and a polyolefin resin.

Korean Patent Publication No. 2005-0115207 (Pegasus international Ltd.,) discloses a method for preparing a paper with a pulp extracted from red algae wherein a gel extract with a low viscosity is extracted from red algae using an acidic solvent and the pulp contains a low content of the gel extract. Korean Patent No. 2005-0092297 issued to Yoo hack-cheol discloses a pulp and paper prepared from red algae and a preparation method thereof.

As foreign patents, U.S. Pat. No. 6,103,790 issued to Elf Atochem S. A. (FR), entitled “Cellulose microfibril-reinforced polymers and their applications” discloses preparation of polymeric composites reinforced with cellulose fibers, rather than algae fibers, and applications thereof.

EP Patent No. 1,007,774 issued to TED LAPIDUS 75.008 Paris, et al., entitled “composite yarn, article containing such yarn and method for making it” discloses preparation of fabrics from algae, which is different from the present invention that uses algae fibers with structural properties as reinforcements.

### SUMMARY OF THE INVENTION

The present invention has been made in view of the problems, and it is one object of the present invention to develop a environmentally-friendly algae fiber-reinforced biocomposite with superior dynamic properties and to provide a method for preparing a biocomposite via introduction of high-temperature grinding so as to improve dispersability of the algae fiber reinforcement contained in the biocomposite.

It is another object of the present invention to provide an algae fiber-reinforced biocomposite with superior structural properties that is suitable both for use as interior and exterior materials of automobiles and houses due to its superior dynamic properties, and that is applicable to a case for electronic products, owing to advantages of algae fibers which includes substantially equivalent crystallinity, and excellent thermal properties such as low thermal expansion and superior thermal stability, as compared to cellulose-based biocomposites.

It is another object of the present invention to provide an environmentally-friendly biocomposite prepared by mixing a polymeric reagent with wasted fibers extracted from algae.

It is yet another object of the present invention to provide an environmentally-friendly biocomposite that has light weight and improved structural properties, when compared to a conventional biocomposite which employs a glass-fiber or cellulose-based natural fiber as a reinforcement.

In accordance with one aspect of the present invention for achieving the above aspect, there is provided a method for preparing a biocomposite, comprising the steps of: drying algae fiber; grinding and dissociating the algae fiber; mixing the algae fiber with a dried polymeric reagent powder wherein the content of the algae fiber is 20 to 60 wt % by weight, based on a total weight of the mixture; and preparing a compression-molded biocomposite by filling a metal mold with the mixture and pressing the mold at a high temperature.

The step of grinding and dissociating algae fiber further includes the steps of: crushing the algae fiber with a mixer; and passing the algae fiber through a sieve with 80 micrometers pores while grinding-dissociating the algae fiber with a high-temperature grinder, to selectively collect fine algae fibers passing through the sieve.

The step of preparing a compression-molded biocomposite includes allowing the polymeric reagent to be melted while the temperature elevates from ambient temperature to 110-200° C., preferably from ambient temperature to 135-180° C., at a rate of 5° C./min and compressing the mold at a pressure of 1,000 psi for 10 to 15 minutes.

The polymeric reagent may be a biodegradable polymer selected from the group consisting of polylactic acid (PLA), polycarprolactone (PCL), a PCL/starch blend and polybutylene succinate (PBS).

The polymeric reagent may be a general polymer selected from the group consisting of thermoplastic resins including polypropylene, polyethylene and polycarbonate.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a flow chart illustrating a method for preparing a biocomposite from seaweed fiber according to the present invention;

FIG. 2A is a SEM image showing a biocomposite in which red algae fiber-reinforcements are well dispersed, according to the present invention;

FIG. 2B is a SEM image showing a biocomposite in which fiber-reinforcements are poorly dispersed;

FIGS. 3 and 4 are graphs showing a comparison in storage modulus and tan delta between the red algae fiber-reinforced biocomposite of the present invention, and conventional biocomposites and a polymeric matrix, respectively;

FIG. 5 is a graph showing comparison in storage modulus between the biocomposite of the present invention, and conventional biocomposites and a polymeric matrix;

FIG. 6 is a graph showing comparison in crystallinity between red algae fiber prepared according to the present invention and cellulose fibers;

FIGS. 7 and 8 are graphs showing comparison in thermal decomposition properties between the red algae fiber prepared according to the present invention and cellulose fibers; and

FIG. 9 is a graph showing comparison in thermal expansion property between various biocomposites prepared by mixing a polybutylene succinate (PBS) polymer as a matrix with a natural fiber as a reinforcement; and

FIGS. 10 and 11 are graphs showing comparison in a thermal expansion property between various biocomposites composed of red algae fiber and a polybutylene succinate (PBS) polymer, according to a content of the red algae fiber.

### DESCRIPTION OF THE PREFERRED EMBODIMENTS

Hereafter the present invention will now be described in greater detail in conjunction with the preferred embodiments such that it can be easily carried out by those skilled in the art.

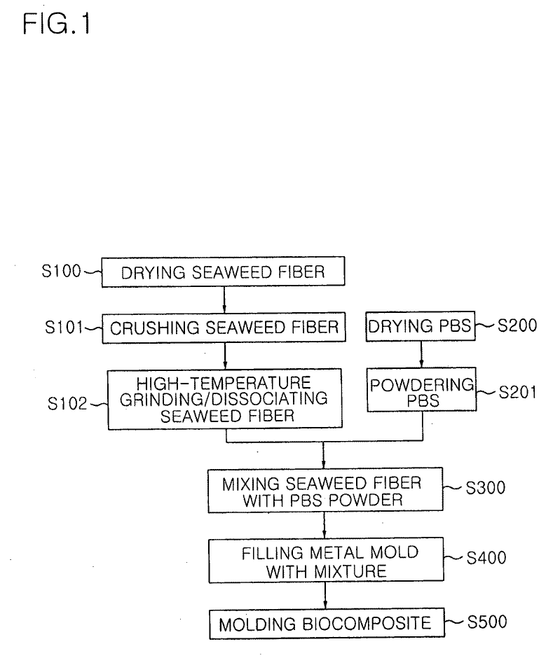

FIG. 1 is a flow chart illustrating a method for preparing a seaweed fiber-reinforced biocomposite according to the present invention. As shown in FIG. 1, the method comprises the steps of: grinding and dissociating dried algae fiber (S100); mixing the algae fiber with a polymeric reagent powder wherein the content of the algae fiber is 20 to 60 wt % by weight, based on a total weight of the mixture (S200); and preparing a compression-molded biocomposite by filling a metal mold with the mixture and pressing the mold at a high temperature (S300).

Prior to the step (S100) of grinding and dissociating algae fibers, the step of removing gel and impurities present in algae and extracting algae fibers from the resulting algae must be carried out. The step of extracting algae fibers includes the sub-steps of: subjecting algae fiber to hydrothermal-treatment twice, once per hour, under the conditions of 120° C. at 3 to 3.5 bar (about 44 psi) and once per hour under the conditions of 100° C. at 1 bar (about 14.5 psi), to remove the gel and impurities of algae; stirring the algae fiber in chlorine dioxide once per hour at 90° C. and then stirring the algae fiber in hydrogen peroxide twice, once per hour, at 90° C., to bleach the algae fiber; washing the algae fiber with water; semi-drying the algae fiber by moisture removal at room temperature; and drying the algae fiber at 100° C. for 24 hours or more.

The step (S100) of grinding and dissociating algae fiber includes the sub-steps of: crushing the algae fiber into smaller algae fiber particles using a mixer for 30 seconds; and passing the algae fiber particles through a sieve with a fine pore size of 80 micrometers, to selectively collect fine particles passing through the sieve, while grinding and dissociating the algae fiber particles with a high-temperature grinder at 5,000 to 10,000 rpm for 25 to 50 seconds. Since the inner temperature of the grinder is in the range of 70 to 100° C., and the temperature of the dried algae fiber is maintained during the grinding and dissociating of the fiber. Accordingly, by maintaining the grinder at the high temperature, it is possible to prevent the algae fiber dried at a high temperature from absorbing moisture of adjacent air, when decreasing in temperature, and to remove the remaining moisture upon grinding-dissociation of the algae fiber into fine fiber particles.

In the step (S200) of mixing the algae fiber with a polymeric reagent powder, there is prepared an integral mixture which contains the fine algae fiber and the polymeric reagent powder, and is in a state where there occurs no separation between the fine algae fiber and the polymeric reagent powder by which the polymeric reagent powder is evenly permeation-dispersed into the fine algae fiber. At this time, the content of the algae fibers is adjusted to 20 to 60 wt % by weight, based on a total weight of the mixture.

The polymeric reagent is divided to a biodegradable and a general polymer. The biodegradable polymer is a material decomposed by biodegradation and is selected from polylactic acid (PLA), polycarprolactone (PCL), a PCL/starch blend and polybutylene succinate (PBS). The general polymer is selected from the group consisting of thermoplastic resins including polypropylene and polyethylene.

In one embodiment of the present invention, red algae which has a uniform fine particle size is used as the algae, and one of biodegradable polymers, polybutylene succinate (PBS) is used as the polymeric reagent.

Of algaes, red algae contain a great deal of fiber known as an “endofiber” and have an almost uniform particle size of several microns. Red algae have crystallinity similar to those of cellulose fibers and exhibit superior thermal stability, as compared to cellulose fibers.

The polymeric reagent in the form of a plastic pellet is dehydrated by drying in a vacuum oven at 80° C. for 5 hours in order to prevent deterioration of biocomposite properties by moisture contained in the polymeric reagent. The dried polymeric reagent is grinded into a powdery form using a mixer and is then mixed with the grinded and dissociated algae fibers.

The step (S300) of preparing a biocomposite is carried out by filling a metal mold with the mixture of the fine algae fiber and the polymeric reagent powder and compression-molding the mold via pressing at a high temperature.

In the case where the mold size is 50 mm×50 mm to secure optimum conditions of the process for preparing the biocomposite using PBS, after the temperature elevates from room temperature to 135° C. at a rate of 5° C./min, high-temperature treating is carried out which has a retention time of about 15 to 20 minutes so that a matrix is sufficiently melted at the final temperature (i.e., 135° C.) and a resin thus flows. On the other hand, when the general polymer is used instead of the PBS, the final temperature must be elevated up to 180° C., since the general polymer has a high melting point, as compared to the biodegradable polymer. During the elevating of the temperature, a melting point of a matrix is varied according to a type and composition of the mixture. Accordingly, the temperature elevates from room temperature to 110 to 200° C. at a rate of 5° C./min, preferably, from room temperature to 135 to 180° C. at a rate of 5° C./min.

Then, the mold is compressed at a pressure of 1,000 psi for 3 to 15 minutes and is cooled to room temperature with cooling water. The molded biocomposite is separated from the mold without any impact from the outside.

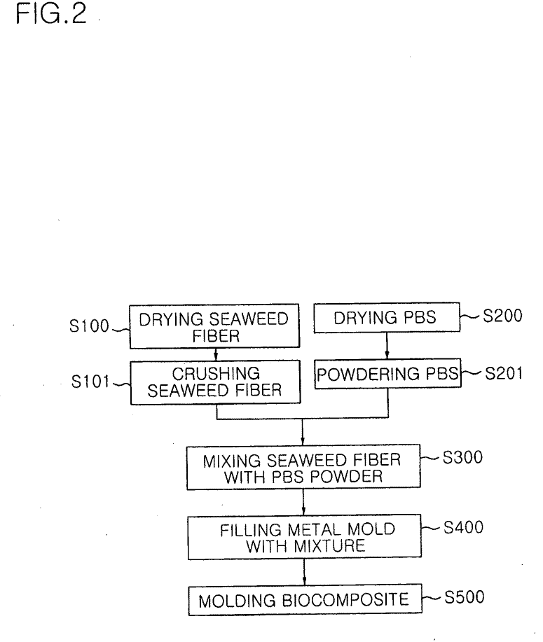

FIG. 2A is an image showing a cross section of the biocomposite prepared according to the present invention and FIG. 2B is an image showing a cross section of the biocomposite which undergoes no grinding/dissociating of algae fiber with a high-temperature grinder. It can be seen from FIG. 2A that red algae fiber is uniformly dispersed in the biocomposite prepared in accordance with the method of the present invention which introduces high-temperature grinding. The biocomposite that uses, as reinforcements, red algae fiber grinded/dissociated with the high-temperature grinder, exhibited excellent dispersability in the polymeric matrix and good adhesion thereto.

On the other hand, it can be confirmed from FIG. 2B that in a case where only mixing of red algae fibers with biodegradable polymeric powders is conducted using a mixer without performing any high-temperature grinding, the red algae fiber get entangled and are insufficiently dispersed into the biocomposite, and that the red algae fiber exhibit poor adhesion with the biodegradable polymeric matrix due to red algae fiber clusters present in the biocomposite.

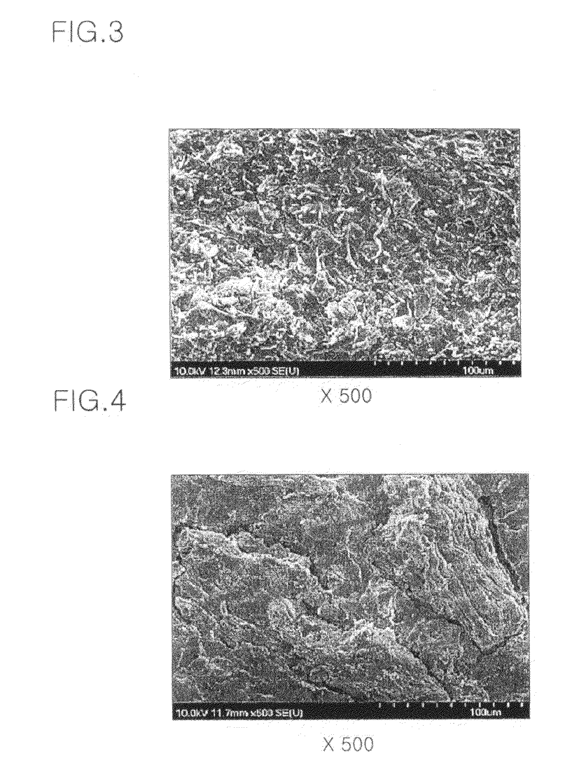

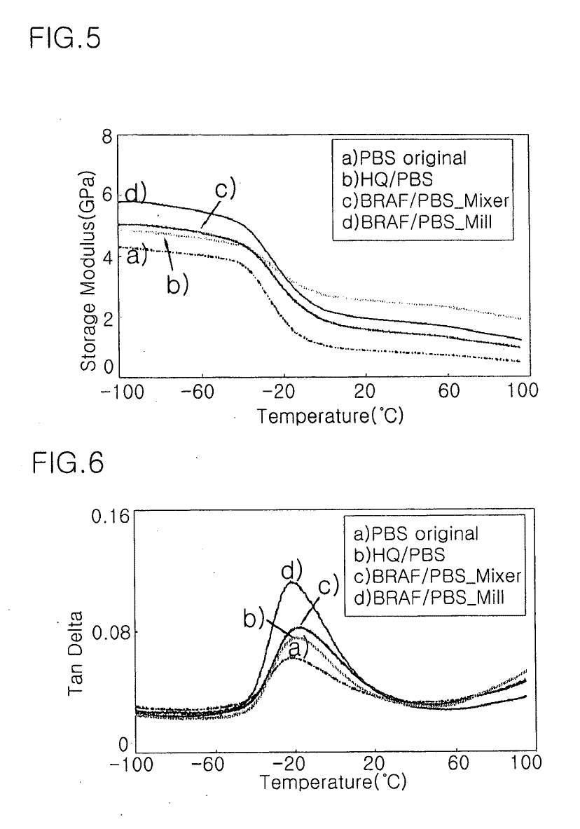

FIGS. 3 and 4 are graphs comparing storage modulus and tan delta as a function of temperature ranging from −100° C. to 100° C. between the biocomposite of the present invention, conventional biocomposites and a biocomposite matrix, and more specifically, a) is a curve of the red algae fiber-reinforced biocomposite of the present invention, b) is a curve of a biocomposite reinforced with red algae fibers which undergo no high-temperature grinding, c) is a curve of a henequen fiber-reinforced biocomposite and d) is a curve of a biocomposite in which only a biodegradable plastic is used as a reinforcement matrix. FIG. 5 is a graph comparing storage modulus at −100° C. and a glass transition temperature (Tg) between the biocomposite matrix according to the present invention and conventional biocomposites and a biocomposite matrix.

From FIG. 5, it can be confirmed that the biocomposite reinforced with red algae fibers drying-dissociated by high-temperature grinding according to the present invention exhibit superior dynamic properties, when compared to red algae- and henequen fiber-reinforced biocomposites which are insufficiently dissociated.

FIG. 6 is a graph showing the crystallinity of a) red algae fibers according to the present invention (red algae bleached fibers) b) crystalline cellulose fibers and c) raw red algae. X-ray diffraction (XRD) patterns of the peaks at 15.4° (2θ) and 22.54° (2θ) reveal that the red algae fibers have the same crystallinity as the cellulose fibers.

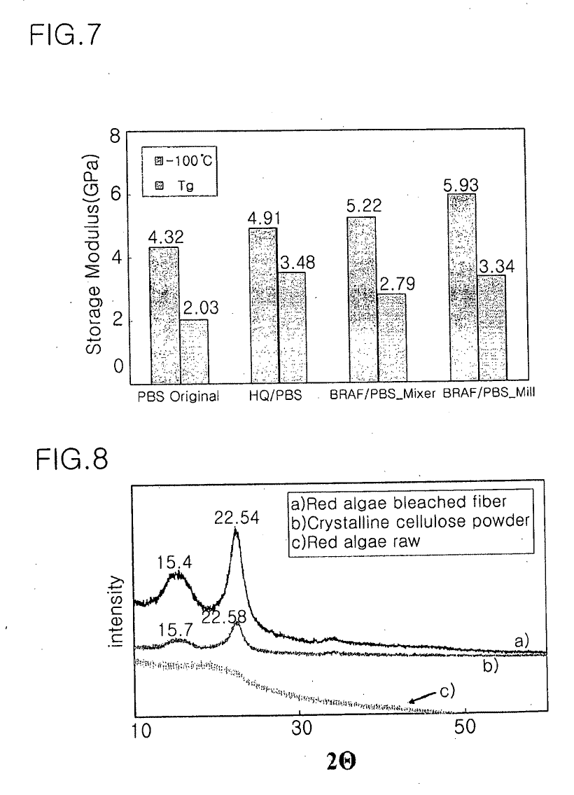

FIGS. 7 and 8 are graphs showing comparison in thermal decomposition properties between a) raw red algae, b) red algae extract, c) red algae bleached fibers (the present invention) and d) crystalline cellulose fibers. The maximum decomposition peak of the red algae fibers is observed at 370° C., whereas the maximum decomposition peak of the cellulose fibers is observed at 370° C. These data reveal that the red algae fibers exhibit superior thermal stability, as compared to the cellulose fibers. The red algae and red algae extract exhibit relatively low thermal stability due to gel components contained therein and show broad peaks. In particular, red algae are thermally decomposed within wide temperature ranges of 50 to 150° C. and 220 to 320° C.

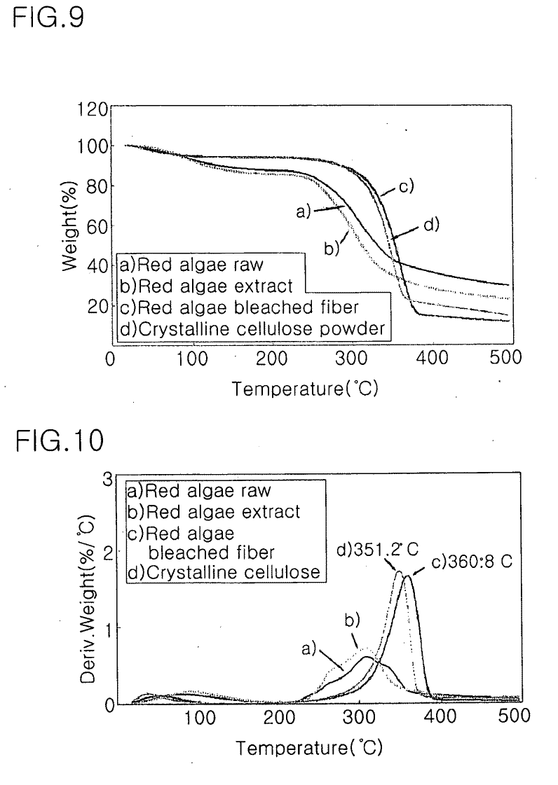

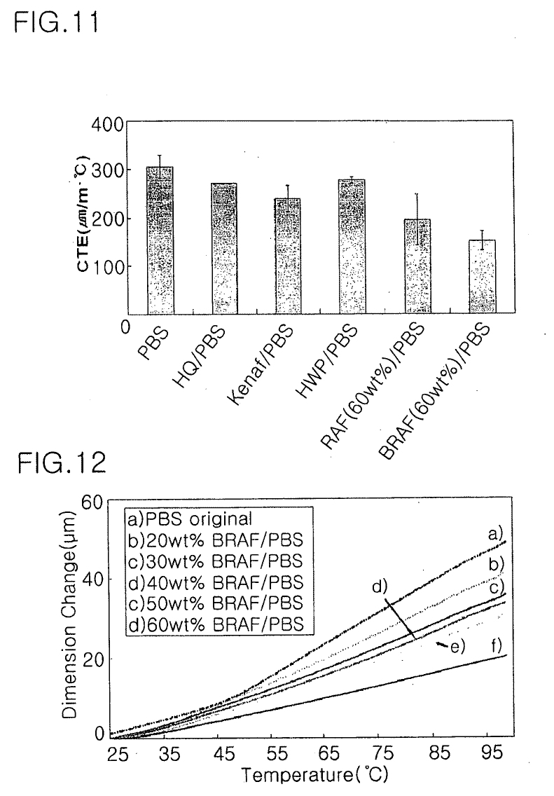

FIG. 9 is a graph showing thermal expansion of biocomposites molded from a mixture of PBS and a varied natural fiber. Based on the total weight of the mixture, the henequen, kenaf and non-coniferous fibers are used in an amount of 30 wt %, and red algae bleached fibers and red algae extract are used in an amount of 60 wt %. As represented by a vertical line in each case, the biocomposite reinforced with red algae which are dried, grinded, dissociated, bleached and purified according to the present invention exhibits the lowest thermal expansion coefficient.

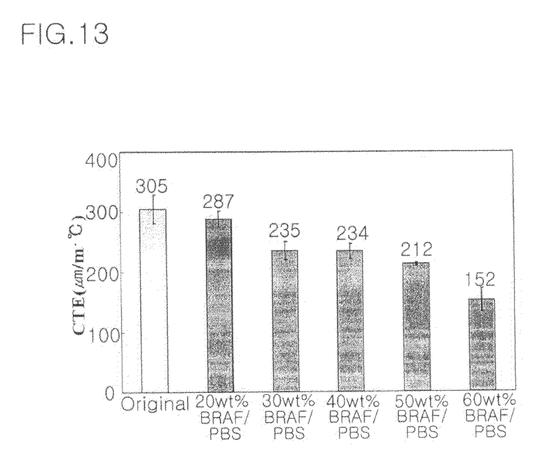

FIGS. 10 and 11 show thermal expansion of a biocomposite composed of a red algae fiber extract and PBS, according to the content of the red algae fiber. FIG. 10 shows thermal expansion behavior of biocomposites in which red algae fibers are each used in a content of 0 wt %, 20 wt %, 30 wt %, 40 wt %, 50 wt % or 60 wt %. FIG. 11 shows the thermal expansion coefficient of each biocomposite in FIG. 10.

As shown in FIGS. 10 and 11, as the content of red algae fibers increases, the thermal expansion coefficient thereof decreases. When the red algae fibers are applied to heat-generating cases for electronic products, they minimize deformation by heat, thus stably supporting and preventing the electronic products.

As apparent from the foregoing, the present invention provides a red algae fiber-reinforced biocomposite that exhibits superior dynamic properties, as compared to cellulose-based biocomposites, and a method for preparing the biocomposite which involves introduction of high-temperature grinding into a conventional preparation method of biocomposites, thereby simultaneously drying, grinding and dissociating the red algae fibers into fine red algae fibers. As a result, it is possible to obtain the fine red algae fibers that are uniformly dispersed in the biocomposite and exhibit superior dynamic properties.

Red algae fiber exhibits substantially equivalent crystallinity and superior thermal stability, as compared to cellulose. According to the present invention, by using the red algae fiber as a biocomposite reinforcement, thermal and mechanical properties can be imparted to the biocomposite. The introduction of high-temperature grinding into a conventional preparation method can solve drawbacks associated with dispersion of reinforcements which cause serious problems in preparation of composite materials.

The biocomposite according to the present invention is a novel advanced material that has advantages of environmental friendliness and energy-saving and has its potential applications for components of houses, automobiles and electronic products. Based on superior properties e.g. light-weight and biodegradability, the biocomposite greatly contributes to energy saving and environmental protection.

Furthermore, the method of the present invention is utilized in a variety of applications e.g. preparation of fiber- and powder-reinforced polymer composites, thereby contributing to improvement in performance of the composites and realizing great advantages.

Besides, algae have advantages of short development period (about 6 months) and low preparation costs, thus realizing mass-production.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-8. (canceled)

9. A method for preparing a biocomposite, comprising the steps of:
grinding and dissociating dried algae fiber (S100);
mixing the algae fiber with a polymeric reagent powder wherein the content of the algae fiber is 20 to 60 wt % by weight, based on a total weight of the mixture (S200); and
preparing a compression-molded biocomposite by filling a metal mold with the mixture and pressing the mold at a high temperature (S300).

10. The method according to claim 9, wherein the step S100 includes the steps of: crushing the algae fiber with a mixer; and grinding-dissociating the algae fiber with a high-temperature grinder, at the same time, passing the algae fiber through a sieve with a predetermined pore size, to selectively collect fine algae fibers passing through the sieve.

11. The method according to claim 10, wherein grinding-dissociation of the crushed algae fiber with the high-temperature grinder is carried out at 5,000 to 10,000 rpm for 25 to 100 seconds at 70 to 100° C.

12. The method according to claim 9, wherein the step S300 includes melting the polymeric reagent while elevating the temperature from ambient temperature to 110-200° C. at a rate of 5° C./min and allowing to stand at a final temperature for a retention time of about 15 to 20 minutes.

13. The method according to claim 12, wherein the temperature elevates from ambient temperature to 135-180° C. at a rate of 5° C./min.

14. The method according to claim 12, wherein the step S300 further includes compressing the mold at a pressure of 1,000 psi for 3 to 15 minutes after the retention time.

15. The method according to claim 14, further comprising: after the compression, cooling the mold to room temperature with cooling water and separating the molded biocomposite from the mold.

16. The method according to claim 9, wherein the polymeric reagent is a biodegradable polymer.

17. The method according to claim 16, wherein the polymeric reagent is selected from the group consisting of polylactic acid (PLA), polycarprolactone (PCL), a PCL/starch blend and polybutylene succinate (PBS).

18. The method according to claim 9, wherein the polymeric reagent is a general polymer.

19. The method according to claim 18, wherein the general polymer is selected from the group consisting of thermoplastic resins including polypropylene, polyethylene and polycarbonate.

20. The method according to claim 9, further comprising:
prior to the step S100,
extracting an algae fiber from algae;
semi-drying the algae fiber; and
drying the algae fibers at 100° C. for 24 hours or more.

21. A biocomposite comprising:
an algae fiber; and
a polymeric reagent.

22. The biocomposite according to claim 21, wherein the algae fiber is contained in an amount of 20 to 60 wt %, based on a total weight of the biocomposite.

23. The biocomposite according to claim 21, wherein the algae fiber is a red algae fiber.

24. The biocomposite according to claim 21, wherein the polymeric reagent is a biodegradable polymer.

25. The biocomposite according to claim 24, wherein the polymeric reagent is selected from the group consisting of polylactic acid (PLA), polycarprolactone (PCL), a PCL/starch blend and polybutylene succinate (PBS).

26. The biocomposite according to claim 21, wherein the polymeric reagent is a general polymer.

27. The biocomposite according to claim 26, wherein the general polymer is selected from the group consisting of thermoplastic resins including polypropylene, polyethylene and polycarbonate.

28. The biocomposite according to claim 21, wherein fine algae fibers are selectively collected from the algae fiber, by drying the algae fiber, crushing the algae fiber with a mixer, and grinding/dissociating the algae fiber with a high-temperature grinder, at the same time passing the algae fiber through a sieve with pores of a predetermined size.

29. The biocomposite according to claim 28, wherein grinding-dissociation of the crushed algae fiber with the high-temperature grinder is carried out at 5,000 to 10,000 rpm for 25 to 100 seconds at 70 to 100° C.

30. The biocomposite according to claim 28, wherein the fine algae fibers and the polymeric reagent are heated from ambient temperature to 110-200° C. at a rate of 5° C./min such that the polymeric reagent is molten, and are allowed to stand at a final temperature for a retention time of about 15 to 20 minutes so that a matrix is sufficiently melted and a resin flows.

31. The biocomposite according to claim 30, wherein the fine algae fibers and the polymeric reagent are heated from ambient temperature to 135-180° C. at a rate of 5° C./min.

32. The biocomposite according to claim 30, wherein the fine algae fibers and the polymeric reagent are compressed at a pressure of 1,000 psi for 3 to 15 minutes after the polymeric reagent is melted.
